(19) United States
(12) Patent Application Publication
(10) Pub. No.: US 2009/0071088 A1
(43) Pub. Date: Mar. 19, 2009

(54) WALL CONSTRUCTION FOR INSULATED ENCLOSURE

(75) Inventors: Herman H. Viegas, Bloomington, MN (US); William F. Mohs, Minneapolis, MN (US); Richard F. Unger, Saulk Centre, MN (US)

Correspondence Address: MICHAEL BEST & FRIEDRICH LLP, 100 E WISCONSIN AVENUE, Suite 3300, MILWAUKEE, WI, 53202, US

(73) Assignee: THERMO KING CORPORATION, Minneapolis, MN (US)

(21) Appl. No.: 11/857,774

(22) Filed: Sep. 19, 2007

(51) Int. Cl. B65D 81/38; B29C 44/02; E04B 1/74

(52) U.S. Cl. 52/406.1; 220/592.2; 220/592.25; 220/592.27; 493/101

(57) ABSTRACT

An enclosure for storing temperature sensitive goods. The enclosure includes a wall that has an interior wall member and an exterior wall member that is spaced apart from the interior wall member to define a gap. The interior wall member partially defines the conditioned space. The enclosure also includes an insulation member that is disposed between the interior wall member and the exterior wall member within the gap. The insulation member has a vacuum insulation panel and foam insulation that is positioned on both sides of the vacuum insulation panel to separate the vacuum insulation panel from the interior wall member and the exterior wall member. The vacuum insulation panel and the foam insulation cooperate to insulate the conditioned space.

### BACKGROUND

The present invention relates to an enclosure that includes insulated walls defining a conditioned space. More particularly, the present invention relates to an enclosure that defines a conditioned space for supporting temperature sensitive goods, and that includes a wall having insulation and wall support members.

Generally, existing enclosures such as cold storage rooms and transport units or containers include walls that define a conditioned space in which goods or cargo can be stored. Typically, the walls are insulated with polyurethane foam that is foamed-in-place, or that consists of extruded foam boards. Some walls of existing enclosures include structural supports that are positioned within the walls to support the walls in a generally vertical orientation. These structural supports are solid members through which a substantial amount of heat transfer can occur between the conditioned space and an environment that surrounds the enclosure. Existing walls are also susceptible to damage and deterioration that can be caused by absorption of moisture from the conditioned space and/or from the environment.

### SUMMARY

In one embodiment, the invention provides an enclosure that supports temperature sensitive goods. The enclosure includes a wall that has an interior wall member and an exterior wall member that is spaced apart from the interior wall member to define a gap. The interior wall member partially defines a conditioned space. The enclosure also includes an insulation member that is disposed between the interior wall member and the exterior wall member within the gap. The insulation member has a vacuum insulation panel and foam insulation that is positioned on both sides of the vacuum insulation panel to separate the vacuum insulation panel from the interior wall member and the exterior wall member. The vacuum insulation panel and the foam insulation cooperate to insulate the conditioned space.

In another embodiment, the invention provides an enclosure that supports temperature sensitive goods, and that includes a wall, a wall support member, and an insulation member. The wall has an interior wall member that partially defines a conditioned space, and an exterior wall member that is spaced apart from the interior wall member to define a gap. The wall support member is disposed between the interior wall member and the exterior wall member within the gap. The wall support member includes a plurality of openings, and is configured to separate and support the interior wall member and the exterior wall member. The insulation member is disposed adjacent the wall support member and between the interior wall member and the exterior wall member within the gap to insulate the conditioned space.

In yet another embodiment, the invention provides a method of manufacturing a wall for an enclosure that defines a conditioned space and that supports temperature sensitive goods. The method includes providing an interior wall member and an exterior wall member that is spaced apart from the interior wall member to define gap. The method also includes positioning a first insulation member, a vacuum insulation panel, and a second insulation member within the gap between the interior wall member and the exterior wall member, and positioning the vacuum insulation panel between the first insulation member and the second insulation member.

In yet another embodiment, the invention provides a method of manufacturing a wall for an enclosure that defines a conditioned space and that supports temperature sensitive goods. The method includes providing an interior wall member and an exterior wall member that is spaced apart from the interior wall member, positioning a wall support member that has a plurality of openings between the interior wall member and the exterior wall member, and supporting the interior wall member and the exterior wall member using the wall support member. The method also includes applying an insulation member in the space between the interior wall member and the exterior wall member, and insulating the conditioned space using the insulation member.

Other aspects of the invention will become apparent by consideration of the detailed description and accompanying drawings.

### BRIEF DESCRIPTION OF THE DRAWINGS

FIG. 1 is a perspective view of an enclosure including enclosure walls defining a conditioned space.

FIG. 2 is a perspective view of a portion of the enclosure walls of FIG. 1 including wall support members and an insulation assembly.

FIG. 3 is a section view of a portion of one of the enclosure walls of FIG. 2 taken along line 3-3.

FIG. 4 is a section view of the enclosure wall of FIG. 3 taken along line 4-4.

FIG. 5 is a perspective view of a portion of enclosure walls of another enclosure having wall support members and an insulation assembly.

FIG. 6 is a section view of a portion of one of the enclosure walls of FIG. 5 taken along line 6-6.

FIG. 7 is a section view of the enclosure wall of FIG. 6 taken along line 7-7.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

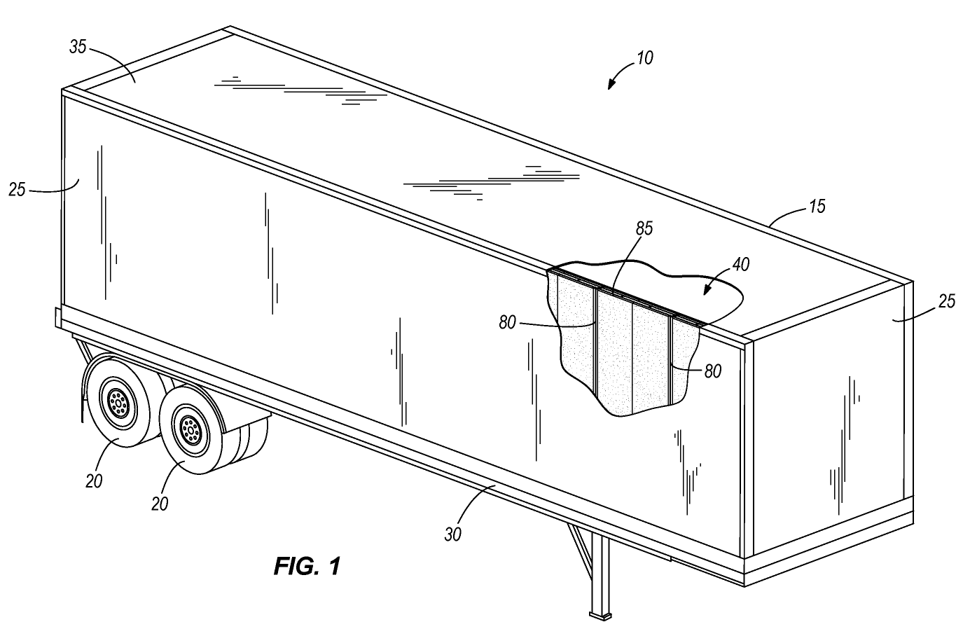

FIG. 1 shows a transport unit or container or enclosure 10 that is suitable for storing and transporting temperature sensitive goods or perishable cargo (e.g., food, medical supplies, flowers, etc.). The illustrated enclosure 10 includes a trailer 15 that has wheels 20, and that is attachable to a vehicle (e.g., straight truck, tractor, etc.) for transporting the cargo in a tractor-trailer combination. In other embodiments, the enclosure 10 can include a free-standing container (e.g., railroad container, ship container, air cargo container, etc.) for storing and/or shipping cargo. In still other embodiments, the cargo may be stored in a stationary enclosure (e.g., cold storage room, refrigerated display case, etc.). Hereinafter, the term “enclosure” shall be used to represent all such movable and stationary enclosures, and shall not be construed to limit the invention's application solely to the trailer 15.

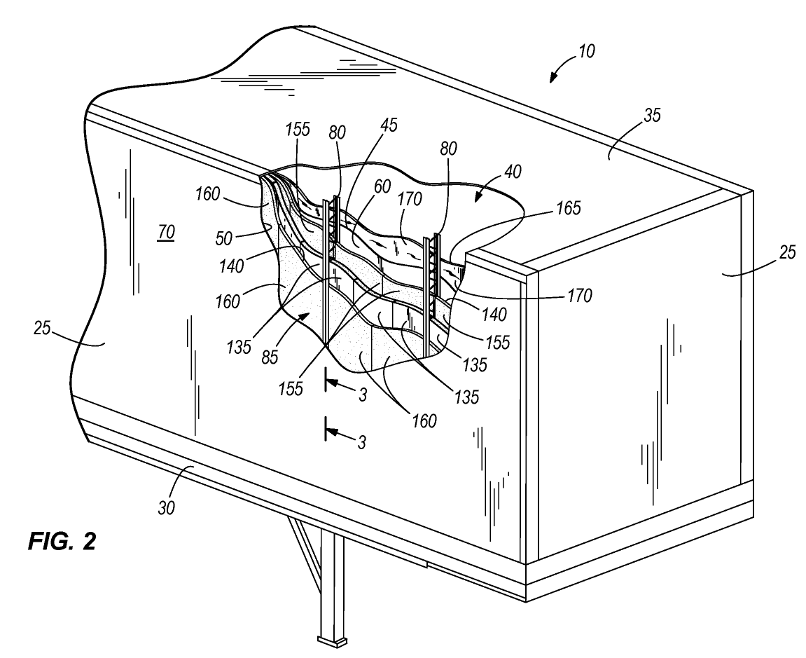

FIGS. 1 and 2 show that the enclosure 10 includes enclosure walls 25, lower wall 30, and an upper wall 35 that define a space 40 that supports cargo. The enclosure 10 also includes one or more doors (not shown) for accessing the space 40. In some embodiments, the enclosure 10 can include a refrigeration system (not shown) that is in communication with the space 40 to maintain the cargo at predetermined conditions during shipment and storage. The refrigeration system can be positioned anywhere on or in the enclosure 10 (e.g., coupled to a forward end of the enclosure 10, coupled to the lower wall 30 underneath the enclosure 10, etc.). The refrigeration system maintains the space 40 at predetermined conditions (e.g., temperature, humidity, etc.) during transportation and storage in order to preserve the quality of the cargo. Generally, the refrigeration system includes one or more refrigeration components (not shown), such as an evaporator, one or more compressors, a condenser, one or more fans, a receiver, and one or more expansion valves. Refrigerant is routed through the components of the refrigeration system. Such arrangements are known in the art.

FIG. 2 shows one of the enclosure walls 25 that includes an interior wall member 45 that partially defines the space 40, and an exterior wall member 50 that is in communication with an environment surrounding the enclosure 10. The interior wall member 45 and the exterior wall member 50 can be formed from plastics or composites. Alternatively, the interior wall member 45 and the exterior wall member 50 can be formed from metal or other suitable materials.

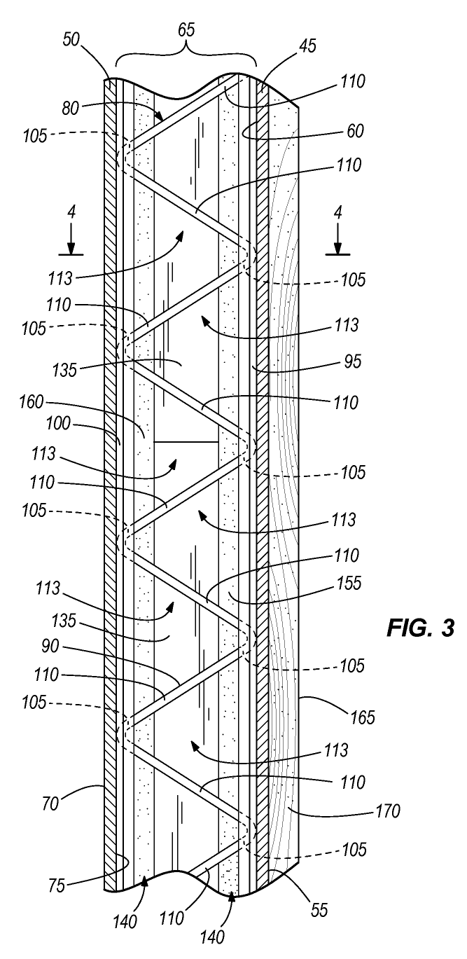

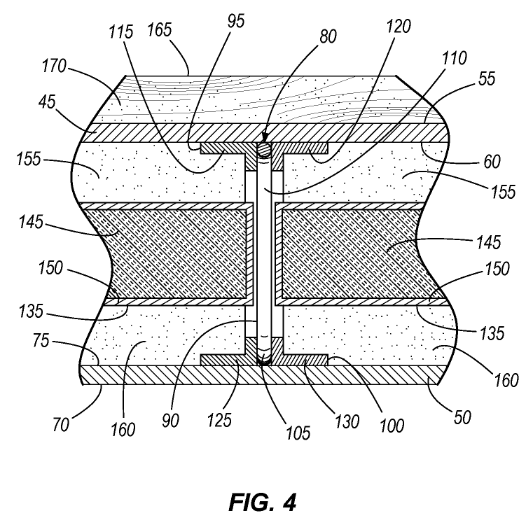

As shown in FIGS. 3 and 4, the interior wall member 45 includes a first surface 55 that is in communication with the space 40, and a second surface 60 that is opposite the first surface 55. Generally, the interior wall member 45 includes panels or sections that are coupled to each other (e.g., with fasteners, etc.) and that define the first and second surfaces 55, 60. In other embodiments, the interior wall member 45 may include one substantially continuous panel or section that defines the first and second surfaces 55, 60.

The exterior wall member 50 is spaced apart from the interior wall member 45 such that the interior wall member 45 and the exterior wall member 50 define a gap 65. The exterior wall member 50 includes a third surface 70 that is in communication with the environment, and a fourth surface 75 that is opposite the third surface 70. Generally, the exterior wall member 50 includes panels or sections that are coupled to each other and that define the third and fourth surfaces 70, 75. In other embodiments, the exterior wall member 45 may include one substantially continuous panel or section that defines the third and fourth surfaces 70, 75.

Each enclosure wall 25 also includes wall supports or wireframe members 80 and an insulation assembly 85. As shown in FIGS. 2-4, the wireframe members 80 are disposed in the gap 65, and extend between and are coupled to the interior wall member 45 and the exterior wall member 50. The wireframe members 80 further extend between the lower wall 30 and the upper wall 35, and are spaced apart from each other a predetermined distance (e.g., one foot, two feet, etc.) so that the enclosure wall 25 is adequately supported.

Each wireframe member 80 includes a wireframe 90, an interior wall attachment 95, and an exterior wall attachment 100. As shown in FIG. 3, the wireframe 90 is a single wire member that is in communication with the interior and exterior wall members 45, 50, and that extends continuously from the lower wall 30 to the roof wall between the interior wall member 45 and the exterior wall member 50. In some embodiments, the wireframe 90 can be formed from metal (e.g., steel, aluminum, etc.). In other embodiments, the wireframe 90 can be formed from a composite or non-metal material (e.g., plastics, fiberglass-reinforced plastic, etc.). In still other embodiments, the wireframe 90 can be formed from a metal and a composite material.

The wireframe 90 includes bent ends 105 and a plurality of wire segments 110 that are coupled to each other adjacent the bent ends 105. Some of the bent ends 105 of the wireframe 90 are engaged with the interior wall member 45, and are attached to the interior wall attachment 95. The remaining bent ends 105 are engaged with the exterior wall member 50, and are attached to the exterior wall attachment 100. In some embodiments, the bent ends 105 are welded or brazed to the interior and exterior wall attachments 95, 100. In other embodiments, the bent ends 105 can be adhered or fastened to the interior and exterior wall attachments 95, 100. In still other embodiments, the bent ends 105 may be clamped or held in place by the interior and exterior wall attachments 95, 100.

The wire segments 110 form openings 113 between adjacent wire segments 110. The wire segments 110 are angularly disposed between the interior wall member 45 and the exterior wall member 50 within the gap 65. In the illustrated embodiment, the wire segments 110 include a circular cross-section that has a diameter between about 0.09 inches and 0.13 inches. In other embodiments, the diameter of the wire segments 110 can be smaller than 0.09 inches or larger than 0.13 inches. In still other embodiments, the wireframe 90 may include a plurality of wire segments 110 that are formed as separate pieces. Alternatively, the wire segments 110 can include other cross-section shapes (e.g., square, triangular, or elliptical). In these embodiments, one end of each separate wire segment 110 can be engaged with or attached to the interior wall member 45 and attached to the interior wall attachment 95, and another end of each separate wire segment 110 can be engaged with or attached to the exterior wall member 50 and attached to the exterior wall attachment 100.

FIG. 4 shows that the interior wall attachment 95 includes a first bracket 115 and a second bracket 120 that are coupled to the second surface 60 of the interior wall member 45. The second bracket 120 is spaced apart from the first bracket 115 such that the bent ends 105 of the wireframe 90 that are adjacent the interior wall member 45 are retained by the interior wall attachment 95 in an abutting relationship with the first and second brackets 115, 120. The first and second brackets 115, 120 orient the wireframe 90 substantially vertically between the lower wall 30 and the upper wall 35. In the illustrated embodiment, the first and second brackets 115, 120 extend continuously along the second surface 60 of the interior wall member 45 between the lower wall 30 and the upper wall 35. In other embodiments, the first and second brackets 115, 120 may be segmented and extend along a portion of the interior wall member 45.

The exterior wall attachment 100 includes a third bracket 125 and a fourth bracket 130 that are coupled to the fourth surface 75 of the exterior wall member 50. The fourth bracket 130 is spaced apart from the third bracket 125 such that the bent ends 105 that are adjacent the exterior wall member 50 are retained by the exterior wall attachment 100 in an abutting relationship with the third and fourth brackets 125, 130. The third and fourth brackets 125, 130 further orient the wireframe 90 substantially vertically between the lower wall 30 and the upper wall 35. In the illustrated embodiment, the third and fourth brackets 125, 130 extend continuously along the fourth surface 75 of the exterior wall member 50 between the lower wall 30 and the upper wall 35. In other embodiments, the third and fourth brackets 125, 130 may be segmented and extend along a portion of the exterior wall member 50.

As shown in FIGS. 3 and 4, the brackets 115, 120, 125, 130 are elongated “L”-shaped wall attachment members or brackets. Other shapes of the brackets 115, 120, 125, 130 are also possible and considered herein. The illustrated embodiment shows two brackets 115, 120 that attach the wireframe 90 to the interior wall member 45, and two brackets 125, 130 that attach the wireframe 90 to the exterior wall member 50. In other embodiments, one bracket may be used to attach the wireframe 90 to the interior wall member 45, and one bracket may be used to attach the wireframe to the exterior wall member 50.

Generally, the wireframe 90 and the brackets 115, 120, 125, 130 can be formed from the same or different material. For example, in some embodiments, the brackets 115, 120, 125, 130 can be formed from metal (e.g., steel, aluminum, etc.). In other embodiments, the brackets 115, 120, 125, 130 can be formed from a composite or non-metal material (e.g., plastics, fiberglass-reinforced plastic, etc.). In still other embodiments, the brackets 115, 120, 125, 130 can be formed from a metal and a composite material.

In some embodiments, the first and second brackets 115, 120 may be adhered or welded or brazed to the interior wall member 45, and the third and fourth brackets 125, 130 may be adhered or welded or brazed to the exterior wall member 50. In other embodiments, the brackets 115, 120, 125, 130 may be attached to the corresponding interior wall member 45 and the exterior wall member 50 using fasteners (e.g., bolts, screws, etc.). Other attachment methods for attaching the brackets 115, 120, 125, 130 to the interior wall member 45 and the exterior wall member 50 are also possible.

With reference to FIGS. 1-4, the insulation assembly 85 is disposed between the interior wall member 45 and the exterior wall member 50 within the gap 65. The insulation assembly 85 further extends between the lower wall 30 and the upper wall 35 along a length of the enclosure 10. As shown in FIGS. 2-4, the insulation assembly 85 includes vacuum insulation panels 135 and foam insulation 140 that is positioned on both sides of the vacuum insulation panels 135. The vacuum insulation panels 135 and the foam insulation 140 cooperate to insulate the space 40.

As shown in FIGS. 2 and 3, the vacuum insulation panels 135 are disposed within the gap 65 and positioned end to end relative to each other, and are substantially centered in the enclosure wall 25 between the interior wall member 45 and the exterior wall member 50. In some embodiments, the vacuum insulation panels 135 may be offset from a center of the enclosure wall 25 between the interior wall member 45 and the exterior wall member 50. In other embodiments, the vacuum insulation panels 135 may be positioned adjacent the interior wall member 45. In still other embodiments, the vacuum insulation panels 135 may be positioned adjacent the exterior wall member 50.

The size of the vacuum insulation panels 135 is partially dependent on the spacing of the wireframe members 80 and the height of the enclosure wall 25 between the lower wall 30 and the upper wall 35. For example, as illustrated in FIG. 2, each vacuum insulation panel 135 includes a width that is less than the distance between adjacent wireframe members 80 such that multiple vacuum insulation panels 135 are positioned between the adjacent wireframe members 80. In other embodiments, the vacuum insulation panels 135 can include a width (e.g., one foot, two feet, etc.) that is substantially equal to the distance between the wireframe members 80 such that one vacuum insulation panel 135 extends horizontally between the adjacent wireframe members 80.

As shown in FIG. 3, each vacuum insulation panel 135 includes a length (e.g., two feet, three feet, etc.) that is shorter than the full height of the enclosure wall 25 between the lower wall 30 and the upper wall 35 such that multiple vacuum insulation panels 135 are stacked or extend vertically between the lower wall 30 and the upper wall 35. In other embodiments, each vacuum insulation panel 135 can extend the full height of the enclosure wall 25 between the lower wall 30 and the upper wall 35.

As shown in FIG. 4, each vacuum insulation panel 135 includes core material 145 (e.g., mineral powder, mineral fiber, fiberglass, silica, open-cell foam, carbon/silica aerogels, open-cell polyurethane foam, polystyrene foam, etc.) that is enclosed by membrane film (e.g., glass, metal, plastic, etc.) in an air-tight envelope or casing 150.

Generally, the casing 150 forms walls of the vacuum insulation panel 135 that surround the core material 145. The core material 145 provides physical support to the casing 150 so that the casing 150 does not collapse when a vacuum is applied to the vacuum insulation panel 135. The casing 150 also provides an effective barrier against atmospheric gases and moisture so that the vacuum can be maintained. In some embodiments, each vacuum insulation panel 135 may also include getters (not shown) and desiccants (not shown). The getters absorb gases within the core material 145, and the desiccants (not shown) absorb moisture within the core material 145. Such vacuum insulation panels 135 are known in the art.

The foam insulation 140 includes a first foam portion 155 that is disposed between the interior wall member 45 and the vacuum insulation panel 135, and a second foam portion 160 that is disposed between the vacuum insulation panel 135 and the exterior wall member 50. The first and second foam portions 155, 160 are further disposed between the wireframe members 80, and extend along the length of the enclosure 10 and between the lower wall 30 and the upper wall 35. In the illustrated embodiment, the thicknesses (e.g., 0.50 inches, one inch, etc.) of the first foam portion 155 and the second foam portion 160 are substantially the same. In other embodiments, the thickness of the first foam portion 155 may be different from the thickness of the second foam portion 160.

As shown in FIG. 2, the first foam portion 155 includes extruded foam board panels (e.g., polyurethane foam, polystyrene foam, etc.) that are disposed along the second surface 60 of the interior wall member 45. The second foam portion 160 includes extruded foam board panels that are disposed along the fourth surface 75 of the exterior wall member 50. In some embodiments, the first foam portion 155 can be bonded or adhered to the interior wall member 45 and/or to the vacuum insulation panels 135 using an adhesive (e.g., epoxy, etc.). Similarly, the second foam portion 160 can be bonded or adhered to the exterior wall member 50 and/or to the vacuum insulation panels 135.

As shown in FIG. 2, each foam board panel includes edges that are coupled to edges of adjacent foam board panels to provide a relatively tight seal between the foam board panels. As shown in FIG. 4, the edges of some of the extruded foam board panels are positioned adjacent and substantially abut the wireframe members 80. In other embodiments, each foam board panel of the first and second foam portions 155, 160 may include foil (e.g., aluminum, plastic, etc.) that is disposed along at least one surface of the foam board panel to limit moisture absorption and to improve thermal resistance through each of the foam portions 155, 160.

The size of the foam board panels of the first foam portion 155 and the second foam portion 160 is partially dependent on the spacing of the wireframe member 80, the height of the enclosure wall 25 between the lower wall 30 and the upper wall 35, and the size of the vacuum insulation panels 135. For example, as illustrated in FIG. 2, each foam board panel includes a width that is less than the distance between adjacent wireframe members 80 such that multiple foam board panels are positioned between the adjacent wireframe members 80. In other embodiments, the foam board panels can include a width (e.g., two feet, three feet, etc.) that is substantially equal to the distance between the wireframe members 80 such that one foam board panel extends horizontally between the adjacent wireframe members 80.

As shown in FIG. 3, each foam board panel extends the full height of the enclosure wall 25 between the lower wall 30 and the upper wall 35. In other embodiments, each foam board panel can include a length (e.g., two feet, three feet, etc.) that is shorter than the full height of the enclosure wall 25 between the lower wall 30 and the upper wall 35 such that multiple foam board panels are stacked or extend vertically between the lower wall 30 and the upper wall 35.

The edges of the extruded foam board panels of the first and second foam portions 155, 160 are offset or staggered from adjoining ends or borders of the vacuum insulation panels 135 so that the ends of the vacuum insulation panels 135 are not aligned with the edges of the foam board panels of the first foam portion 155 or the second foam portion 160. In other words, the foam board panels of the first foam portion 155 bridge the ends of the vacuum insulation panels 135 along one side of the vacuum insulation panels 135, and the foam board panels of the second foam portion 160 bridge the ends of the vacuum insulation panels 135 along the other side of the vacuum insulation panels 135.

In some embodiments, the first foam portion 155 and/or the second foam portion 160 can include foamed-in-place insulation (e.g., liquid foam insulation, spray foam, blown-in insulation, etc.) that extends along the length of the enclosure 10 and between the lower wall 30 and the upper wall 35. The foamed-in-place insulation can be sprayed or applied within the gap 65 against the vacuum insulation panels 135. In these embodiments, the foamed-in-place insulation can also extend through the openings 113 between the wire segments 110 to insulate the enclosure wall 25 adjacent the wireframe members 80.

In some embodiments, the lower wall 30 and the upper wall 35 are similar to the enclosure walls 25, and include the wireframe members 80 to provide support to the respective wall 30, 35, and the insulation assembly 85 to insulate the respective wall 30, 35. Similarly, the doors of the enclosure 10 may also include the wireframe members 80 and the insulation assembly 85. As such, the lower wall 30, the upper wall 35, and the doors will not be discussed in detail. In other embodiments, the lower wall 30, the upper wall 35, and/or the doors may include other structural supports and/or other insulation to thermally protect the space 40.

The enclosure 10 also includes a panel member 165 that is coupled to the first surface 55 of the interior wall member 45 such that the panel member 165 is in communication with the space 40. As shown in FIGS. 2-4, the panel member 165 includes a plurality of elongated panels 170 that extend along the length of the interior wall member 45 to protect the enclosure wall 25.

The panel member 165 can extend vertically a partial or full height along the enclosure walls 25. For example, the panel member 165 may extend vertically from the lower wall 30 one-third of the height of the enclosure walls 25. Generally, the distance that the panel member 165 extends vertically along the enclosure wall 25 depends at least in part on portions of the enclosure walls 25 that may need additional protection. The panel member 165 can be attached to the interior wall member 45 with an adhesive, or with fasteners. Other methods of attachment may also be used to attach the panel member 165 to the interior wall member 45. In other embodiments, the panel member 165 may be coupled to the interior wall member 45 and to the exterior wall member 50. In still other embodiments, the enclosure 10 may not include the panel member 165.

In the illustrated embodiment, the panel member 165 includes plywood (e.g., oriented strand board, etc.) that has a thickness of approximately 0.5 inches. In some embodiments, the panel member 165 may have a thickness that is larger or smaller than 0.5 inches. In other embodiments, the panel member 165 may include solid wood (e.g., pine, oak, maple, etc.). In still other embodiments, the panel member 165 may include other materials (metals, plastics, composites, etc.).

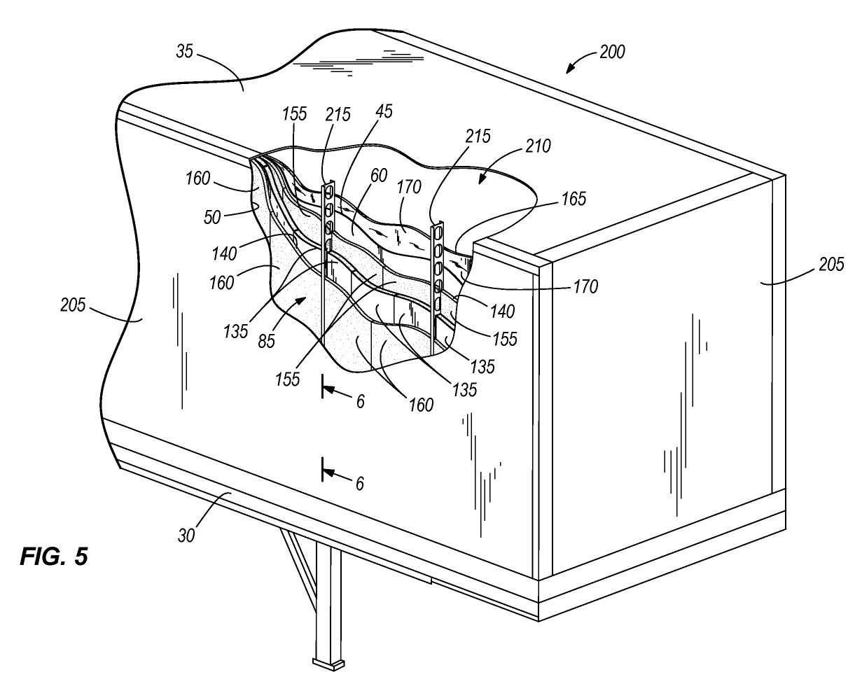

FIGS. 5-7 show another embodiment of an enclosure 200 that has enclosure walls 205 defining a conditioned space 210. Except as described below, the enclosure walls 205 are similar to the enclosure walls 25 described above with regard to FIGS. 1-4, and common elements are given the same reference numerals.

Each enclosure wall 205 includes the interior wall member 45, the exterior wall member 50, the insulation assembly 85 that has the vacuum insulation panels 135 and the foam insulation 140 positioned on both sides of the vacuum insulation panels 135, and the panel member 165. The enclosure wall 205 also includes wall supports or brackets 215. The brackets 215 are disposed in the gap 65, and extend between and are coupled to the interior wall member 45 and the exterior wall member 50. The brackets 215 further extend between the lower wall 30 and the upper wall 35, and are spaced apart from each other along a length of the enclosure 200 a predetermined distance so that the enclosure wall 25 is adequately supported. In some embodiments, the brackets 215 can be formed from metal (e.g., steel, aluminum, etc.). In other embodiments, the brackets 215 can be formed from a composite or non-metal material (e.g., plastics, fiberglass-reinforced plastic, etc.). In still other embodiments, the brackets 215 can be formed from a metal and a composite material.

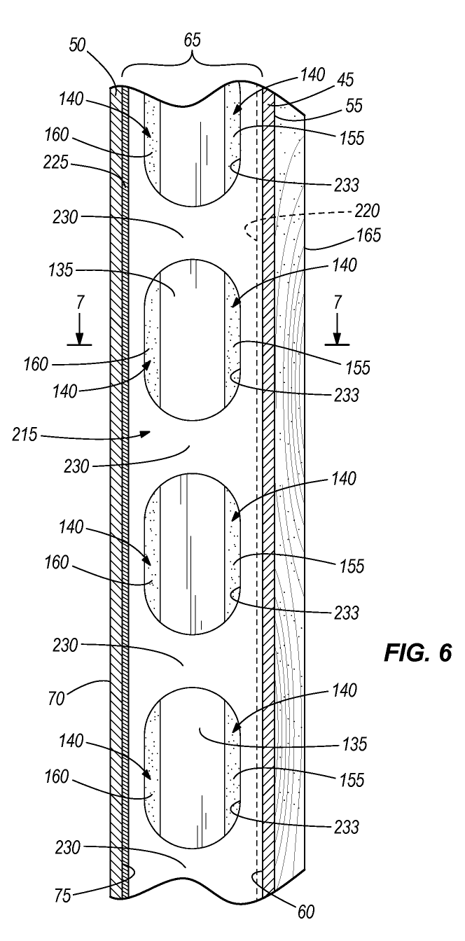

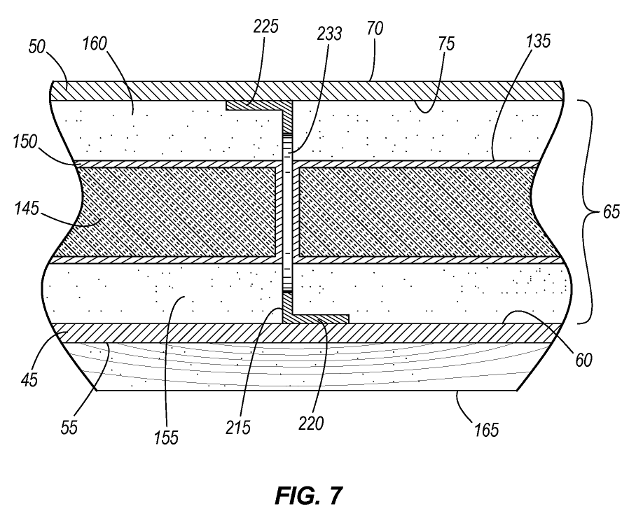

As shown in FIGS. 6 and 7, each bracket 215 includes an interior wall portion 220, an exterior wall portion 225, and a central portion 230 that extends between the interior wall portion 220 and the exterior wall portion 225. In the illustrated embodiment, the interior wall portion 220 extends from a first side of the central portion 230, and the exterior wall portion 225 extends from a second side of the central portion 230 that is opposite the first side of the central portion 230. In other words, the illustrated bracket 215 are “Z” brackets. In some embodiments, the brackets 215 can include “U” brackets that are defined by the interior wall portion 220 and the exterior wall portion 225 extending from the same side of the central portion 230. In other embodiments, the brackets 215 can include central portions 230 that are defined by curved or flat plates.

The interior wall portion 220 and the exterior wall portion 225 of each bracket 215 can be attached to the interior wall member 45 and the exterior wall member 50, respectively, with fasteners (e.g., bolts, screws, etc.). In other embodiments, the wall portions 220, 225 may be bonded or brazed or welded to the respective wall members 45, 50.

As shown in FIGS. 6 and 7, each central portion 230 includes openings 233 that are spaced apart a predetermined distance along the bracket 215. The openings 233 limit heat transfer between the interior wall member 45 and the exterior wall member 50 along the bracket 215. In embodiments of the enclosure wall 25 that includes foamed-in-place insulation coupled to the vacuum insulation panels 135, the foamed-in-place insulation may extend through the openings 233 to provide a substantially continuous insulation layer adjacent the interior wall member 45.

In some embodiments, other components associated with the enclosure 10, 200 (e.g., logistics tracks, accessory attachments, electrical wiring, conduit, etc.) can be coupled to the enclosure walls 25 and/or to the lower wall 30 and/or to the upper wall 35. For example, logistics tracks (not shown) can be disposed in the walls 25, 30, 35 to hold and support cargo within the space 40. Generally, the logistics tracks can extend along the first surface of the interior wall member 45 and are in communication with the space 45. In some embodiments, the logistics tracks attach to the wireframe members 80 or the brackets 215. Other accessories or components can also be recessed within the enclosure walls 25, the lower wall 30, and/or the upper wall 35. Spacers (not shown) can be positioned between the interior wall member 45 and the wireframe members 80 or the brackets 215 to separate the interior wall member 45 from the wireframe members 80 or the brackets 215 so that the logistics tracks and/or other accessories can be positioned within troughs or gaps between the wireframe members 80 or the brackets 215 and the walls 25, 30, 35. Such component and accessory attachments are known in the art.

Each enclosure wall 25, 205 is constructed by positioning the wireframe members 80 or the brackets 215 between the interior wall member 45 and the exterior wall member 50 within the gap 65. As described above, the wireframe members 80 have structure that differs from the structure of the brackets 215. However, construction of the enclosure walls 25 and the enclosure walls 205 are similar, and will not be described separately. As such, for purposes of describing the construction of the enclosure walls 25, 205, the term “wall supports” shall be used to represent the wireframe members 80 and the brackets 215.

Generally, the exterior wall member 50 is placed against a substantially flat surface, and the wall supports are attached to the exterior wall member 50. The wall supports separate and support the interior and exterior wall members 45, 50, and resist buckling of the enclosure wall 25, 205. The second foam portion 160 is coupled to the fourth surface 75 of the exterior wall member 50 and attached to the exterior wall member 50 with an adhesive (e.g., epoxy, glue, etc.) after the wall supports are attached to the exterior wall member 50. In other embodiments, the second foam portion 160 can be coupled to the fourth surface 75 of the exterior wall member 50 without adhesive or other fasteners. In embodiments that include one foam board panel disposed between adjacent wall supports, the edges of the foam board panel of the second foam portion 160 substantially abut the adjacent wall supports. In embodiments that include multiple foam board panels disposed between adjacent wall supports, the edges of each foam board panel abut corresponding edges of adjacent foam board panels between the adjacent wall supports such that the foam board panels extend substantially end-to-end between the wall supports.

The vacuum insulation panels 135 are coupled to the second foam portion 160 after the second foam portion 160 has been coupled to the exterior wall member 50. In embodiments that include multiple foam board panels and/or multiple vacuum insulation panels 135 disposed between adjacent wall supports, the vacuum insulation panels 135 are coupled to the second foam portion 160 so that the ends of each vacuum insulation panel 135 are generally staggered relative to the edges of each foam board panel of the second foam portion 160. For example, in embodiments that include multiple foam board panels and/or multiple vacuum insulation panels 135 horizontally disposed between adjacent wall supports, the vacuum insulation panels 135 are coupled to the foam board panels of the second foam portion 160 so that the edges of each foam board panels are staggered horizontally relative to the ends of each vacuum insulation panel 135. In embodiments that include the second foam insulation 160 and/or the vacuum insulation panels 135 that are shorter than the overall height of the enclosure walls 25, 205, the ends of each vacuum insulation panel 135 are staggered vertically relative to the edges of each foam board panel.

The ends of each vacuum insulation panel 135 abut corresponding ends of adjacent vacuum insulation panels 135 between the wall supports. When assembled, the vacuum insulation panels 135 extend substantially end-to-end between the wall supports. The vacuum insulation panels 135 can be attached to the second foam portion 160 with adhesive. In other embodiments, the vacuum insulation panels 135 may be coupled to the second foam portion 160 without adhesive or other fasteners.

After the vacuum insulation panels 135 are positioned between the wall supports, the foam board panels of the first foam portion 155 are coupled to the vacuum insulation panels 135. The first foam portion 155 is attached to the vacuum insulation panels 135 with adhesive (e.g., epoxy, glue, etc.). In other embodiments, the first foam portion 155 can be coupled to the vacuum insulation panels 135 without adhesive or other fasteners.

The edges of each foam board panel of the first foam portion 155 abut corresponding edges of adjacent foam board panels between the wall supports such that the foam board panels extend substantially end-to-end between the wall supports. The foam board panels of the first foam portion 155 are coupled to the vacuum insulation panels 135 such that the edges of the foam board panels are generally staggered relative to the ends of the vacuum insulation panels 135. For example, in embodiments that include multiple foam board panels and/or multiple vacuum insulation panels 135 horizontally disposed between adjacent wall supports, the foam board panels of the first foam portion 155 are coupled to the vacuum insulation panels 135 so that the edges of each foam board panel are staggered horizontally relative to the ends of each vacuum insulation panel 135. In embodiments that include the first foam insulation 155 and/or the vacuum insulation panels 135 that are shorter than the overall height of the enclosure walls 25, 205, the ends of each vacuum insulation panel 135 are staggered vertically relative to the edges of each foam board panel.

The vacuum insulation panels 135 are retained between the first foam portion 155 and the second foam portion 160 so that the vacuum insulation panels 135 are spaced apart from the interior wall member 45 and the exterior wall member 50. In embodiments that include the first foam portion 155 and the second foam portion 160 with substantially the same thickness, the vacuum insulation panels 135 are further substantially centered between the interior wall member 45 and the exterior wall member 50. In embodiments that include the vacuum insulation panels 135 offset from a substantially equidistant position between the interior wall member 45 and the exterior wall member 50, the vacuum insulation panels 135 are generally positioned closer to the wall member 45, 50 that is least likely sustain damage during use of the enclosure 10. In these embodiments, spacers (e.g., foam, plastic, etc.) may be used to separate the vacuum insulation panels 135 from the interior wall member 45 or the exterior wall member 50.

The interior wall member 45 is attached to the wall supports to enclose the assembled wall supports and insulation assembly 85. The interior wall member 45 can be attached to the first foam portion 155 along the second surface 60 with an adhesive. In other embodiments, the interior wall member 45 can be coupled to the first foam portion 155 without an adhesive or other fasteners. In the illustrated embodiment, the panel member 165 is then coupled to the first surface 55 of the interior wall member 45 to protect the enclosure wall 25, 205 from damage, and to provide additional support for the enclosure wall 25, 205. As discussed above, the panel member 165 may be coupled to one or both of the interior wall member 45 and the exterior wall member 50 and disposed inside or outside the gap 65 to protect the enclosure wall 25, 205.

In embodiments that include foamed-in-place insulation for the first foam portion 155 and/or the second foam portion 160, the foamed-in-place insulation can be applied to the vacuum insulation panels 135 to provide substantially continuous insulation along the length of the enclosure wall 25, 205. The foamed-in-place insulation fills voids that may occur between ends of adjacent vacuum insulation panels 135, and partially insulates the enclosure wall 25, 205 in voids or uninsulated spaces that may be formed by the wall supports and/or by the insulation assembly 85. The foamed-in-place insulation also can extend through the openings 113, 233 formed by the wall supports, which further insulates the enclosure wall 25, 205.

The construction of the enclosure walls 25, 205 has been described as if the enclosure wall 25, 205 was being built starting with the exterior wall member 50, and attaching the wall supports and the insulation assembly 85 to the exterior wall member 50 prior to attachment of the interior wall member 45 and the panel member 165 to the wall supports and the insulation assembly 85. However, construction of the enclosure walls 25, 205 can also be accomplished by starting with the interior wall member 45, and attaching the wall supports and the insulation assembly 85 to the interior wall member 45 prior to attachment of the exterior wall member 50 to the wall supports and the insulation assembly 85. Other construction methods of the enclosure walls 25, 205 are also possible and considered herein.

Generally, when foamed-in-place insulation is used for the first foam portion 155 in construction of the enclosure walls 25, 250 that start with the exterior wall member 50, the interior wall member 45 is attached to the wall supports prior to insertion of the foamed-in-place insulation. Similarly, when foamed-in-place insulation is used for the second foam portion 160 in construction of the enclosure walls 25, 250 that start with the interior wall member 45, the exterior wall member 50 is attached to the wall supports prior to insertion of the foamed-in-place insulation. The foamed-in-place insulation is inserted or applied between the assembled interior wall member 45 and exterior wall member 50 so that the foamed-in-place insulation fills any voids or uninsulated spaces that may exist in the enclosure wall 25, 205.

In some embodiments, the first and second foam portions 155, 160 may include foamed-in-place insulation. In these embodiments, the interior wall member 45 and the exterior wall member 50 are supported by the wall supports, and the vacuum insulation panels 135 are spaced apart from the interior wall member 45 and the exterior wall member 50 using spacers (e.g., foam spacers, etc.). The foamed-in-place insulation is then inserted into the voids defined between the interior wall member 45 and the vacuum insulation panels 135, and between the exterior wall member and the vacuum insulation panels. The foamed-in-place insulation can be inserted into the voids on both sides of the vacuum insulation panels 135 simultaneously, or alternatively, the foamed-in-place insulation can be inserted into each void separately.

In some embodiments, the wall supports can be pre-insulated prior to attachment of the wall supports to the interior wall member 45 and the exterior wall member 50. For example, foam insulation (e.g., foam board panels, foamed-in-place insulation, etc.) may be positioned between the interior wall attachment 95 and an exterior wall attachment 100 of the wireframe member 80 so that the wireframe member 80 and the foam insulation cooperate to define a substantially rectangular cross-section. Similarly, foam insulation can be positioned between the interior wall portion 220 and the exterior wall portion 225 along the central portion 230 so that the bracket 215 and the foam insulation cooperate to define a substantially rectangular cross-section. In these embodiments, the foam insulation further insulates the enclosure walls 25, 205 adjacent the wall supports so that thermal losses through the enclosure walls 25, 205 are further limited. The substantially rectangular cross-section provides a pre-insulated wall support and relatively easy and straight forward assembly of the vacuum insulation panels 135 and the first and second foam portions 155, 160 into the gap 65 between adjacent wall supports. The pre-insulated wall supports also limit the existence of voids that can otherwise form due to the different shapes of the wall supports and the insulation assembly 85.

The assembled enclosure wall 25, 205 provides thermal protection for the conditioned space 40 and inhibits thermal losses through the enclosure wall 25, 205 and through the wall supports. The openings 113 defined by the wire segments 110 of each wireframe 90 and the openings 233 in each bracket 215 substantially limit heat transfer between the interior wall member 45 and the exterior wall member 50 through the respective wall support. The insulation assembly 85 effectively insulates the space 40 so that cargo positioned in the space 40 can be maintained at predetermined conditions.

The segmentation of the vacuum insulation panels 135 and the foam board panels of the foam insulation 140 within the enclosure wall 25, 205 allow the wall support and/or one or more portions of the insulation assembly 85 to be replaced without replacing the entire insulation assembly 85, and without replacing the entire enclosure wall 25, 205. The staggered vacuum insulation panels 135 relative to the edges of the foam board panels of the first foam portion 155 and the second foam portion 160 break up a heat transfer path defined by the joints between the vacuum insulation panels 135 and the foam insulation 140, which limits heat transfer through the enclosure wall 25, 205.

The wall supports, the insulation assembly 85, and the panel member 165 also allow flexing of the enclosure wall 25, 205 in response to forces that may act on the enclosure wall 25, 205 from outside the enclosures 10, 200, or from inside the space 40. In addition, the foam board panels or foamed-in-place insulation for the first foam portion 155 and the second foam portion 160 protect the vacuum insulation panels 135 from damage from by acting as a cushion on both sides of the vacuum insulation panels 135.

In some embodiments, the enclosure wall 25, 205 can be constructed without the wireframe members 80 or the brackets 215. In these embodiments, the insulation assembly 85 provides a substantial amount of support to the enclosure wall 25, 205. Without a wall support disposed between the interior wall member 45 and the exterior wall member 50, heat transfer through the enclosure wall 25, 205 can be substantially limited.

Various features and advantages of the invention are set forth in the following claims.

What is claimed is:

1. An enclosure for storing temperature sensitive goods, the enclosure comprising:
a wall including an interior wall member and an exterior wall member spaced apart from the interior wall member to define a gap, the interior wall member partially defining a conditioned space;
an insulation member disposed between the interior wall member and the exterior wall member within the gap, the insulation member including a vacuum insulation panel and foam insulation positioned on both sides of the vacuum insulation panel to separate the vacuum insulation panel from the interior wall member and the exterior wall member, the vacuum insulation panel and the foam insulation cooperating to insulate the conditioned space.

2. The enclosure of claim 1, wherein the vacuum insulation panel is centered between the interior wall member and the exterior wall member.

3. The enclosure of claim 1, wherein the foam insulation includes a first foam portion disposed between the interior wall member and the vacuum insulation panel, and a second foam portion disposed between the exterior wall member and the vacuum insulation panel.

4. The enclosure of claim 3, further comprising an elongated panel member coupled to the interior wall member along a surface of the interior wall member and disposed opposite the first foam portion such that the elongated panel member is in communication with the conditioned space.

5. The enclosure of claim 4, wherein the elongated panel member includes wood.

6. The enclosure of claim 1, wherein the foam insulation includes at least one of foamed-in-place insulation and foam board insulation.

7. The enclosure of claim 1, wherein the foam insulation is coupled to at least one of the interior wall member and the vacuum insulation panel with an adhesive.

8. The enclosure of claim 1, wherein the foam insulation is coupled to at least one of the exterior wall member and the vacuum insulation panel with an adhesive.

9. The enclosure of claim 1, wherein a foil member is disposed on at least one surface of the foam insulation to resist moisture transfer through the wall.

10. The enclosure of claim 1, wherein the foam insulation includes polyurethane foam.

11. An enclosure for storing temperature sensitive goods, the enclosure comprising:
a wall including an interior wall member and an exterior wall member spaced apart from the interior wall member to define a gap, the interior wall member partially defining a conditioned space;
a wall support member disposed between the interior wall member and the exterior wall member within the gap, the wall support member including a plurality of openings and configured to separate and support the interior wall member and the exterior wall member;
an insulation member disposed adjacent the wall support member and between the interior wall member and the exterior wall member within the gap to insulate the conditioned space.

12. The enclosure of claim 11, wherein the wall support member includes a wireframe member that has a plurality of wire segments angularly disposed between the interior wall member and the exterior wall member.

13. The enclosure of claim 12, wherein the wireframe member further includes at least one wall attachment member to attach the plurality of wire segments to the interior wall member and at least another wall attachment member to attach the plurality of wire segments to the exterior wall member.

14. The enclosure of claim 12, wherein each of the plurality of wire segments includes a diameter between about 0.09 inches and 0.13 inches.

15. The enclosure of claim 11, wherein the wall support member includes a bracket member coupled to the interior wall member and the exterior wall member, and wherein the bracket member has a central portion defining the plurality of openings.

16. The enclosure of claim 11, further comprising an elongated panel member coupled to the interior wall member along a surface of the interior wall member and disposed opposite the insulation member such that the elongated panel member is in communication with the conditioned space.

17. The enclosure of claim 16, wherein the elongated panel member includes wood.

18. The enclosure of claim 11, wherein the insulation member includes polyurethane foam.

19. The enclosure of claim 11, wherein the insulation member includes a vacuum insulation panel and foam insulation positioned on both sides of the vacuum insulation panel to separate the vacuum insulation panel from the interior wall member and the exterior wall member.

20. The enclosure of claim 19, wherein the vacuum insulation panel is centered between the interior wall member and the exterior wall member.

21. The enclosure of claim 19, wherein the foam insulation includes at least one of foamed-in-place insulation and foam board insulation.

22. The enclosure of claim 11, wherein the insulation member is coupled to at least one of the interior wall member and the exterior wall member with an adhesive.

23. The enclosure of claim 11, wherein a foil member is disposed on at least one surface of the insulation member to resist moisture transfer through the wall.

24. The enclosure of claim 11, further comprising foam insulation attached to the wall support such that the wall support and the foam insulation define a substantially rectangular cross-section.

25. The enclosure of claim 11, wherein the wall support member is formed from at least one of a metal and a composite material.

26. A method of manufacturing a wall for an enclosure defining a conditioned space and supporting temperature sensitive goods, the method comprising:
providing an interior wall member and an exterior wall member spaced apart from the interior wall member to define gap;
positioning a first insulation member, a vacuum insulation panel, and a second insulation member within the gap between the interior wall member and the exterior wall member; and
positioning the vacuum insulation panel between the first insulation member and the second insulation member.

27. The method of claim 26, further comprising applying an elongated panel member to the interior wall member on a surface of the interior wall member.

28. The method of claim 26, wherein positioning the first insulation member includes positioning at least one of foamed-in-place insulation and foam board insulation between the interior wall member and the exterior wall member.

29. The method of claim 26, further comprising
attaching the first insulation member to the exterior wall using an adhesive; and
attaching the vacuum insulation panel to the first insulation member using an adhesive.

30. The method of claim 29, further comprising positioning at least one of the first insulation member and the second insulation member against the vacuum insulation panel by positioning foamed-in-place insulation between the vacuum insulation panel and the interior wall member.

31. The method of claim 30, further comprising supporting the interior wall member and the exterior wall member using a wall support member that has a plurality of openings.

32. The method of claim 31, further comprising
insulating the wall support member with foam insulation;
positioning the wall support member including the foam insulation within the gap between the interior wall member and the exterior wall member; and
positioning the first insulation member, the vacuum insulation panel, and the second insulation member against the wall support member.

33. A method of manufacturing a wall for an enclosure defining a conditioned space and supporting temperature sensitive goods, the method comprising:
providing an interior wall member and an exterior wall member spaced apart from the interior wall member;
positioning a wall support member between the interior wall member and the exterior wall member, the wall support member including a plurality of openings;
supporting the interior wall member and the exterior wall member using the wall support member;
positioning an insulation member in the space between the interior wall member and the exterior wall member; and
insulating the conditioned space using the insulation member.

34. The method of claim 33, wherein supporting the interior wall member and the interior wall member using the wall support member includes positioning a wireframe member having a plurality of angularly spaced wire segments defining the plurality of openings between the interior wall member and the exterior wall member.

35. The method of claim 33, wherein supporting the interior wall member and the interior wall member using the wall support member includes positioning a bracket member having the plurality of openings between the interior wall member and the exterior wall member.

36. The method of claim 33, further comprising insulating the wall support member with foam insulation prior to positioning the wall support member between the interior wall member and the exterior wall member.

37. The method of claim 36, further comprising positioning the insulation member against the insulated wall support member.
